(19) United States
(12) Patent Application Publication
(10) Pub. No.: US 2014/0372163 A1
(43) Pub. Date: Dec. 18, 2014

(54) METHODS AND SYSTEMS FOR ADJUSTING COMPENSATION FOR TASKS

(71) Applicant: Xerox Corporation, Norwalk, CT (US)

(72) Inventors: Guangyu Zou, Webster, NY (US); Lina Fu, Fairport, NY (US); Rakesh Kulkarni, Webster, NY (US)

(21) Appl. No.: 13/919,206

(22) Filed: Jun. 17, 2013

(51) Int. Cl. G06Q 10/06

(52) U.S. Cl. CPC G06Q 10/06312
USPC 705/7.22

(57) ABSTRACT

Method and system for dynamically adjusting compensation for one or more tasks are disclosed. The method includes estimating the compensation for each task in a batch of tasks based on at least one of a minimum wage for a task in the batch of tasks, one or more attributes associated with the worker, a number and type of tasks in the batch of tasks, or a target level of service. The compensation for the each task of the batch of tasks is then adjusted based on at least one of an observed level of service associated with the batch of tasks and the target level of service. The method is performed using a processor.

### TECHNICAL FIELD

The presently disclosed embodiments are related, in general, to crowdsourcing. More particularly, the presently disclosed embodiments are related to systems and methods for adjusting compensation for one or more tasks.

### BACKGROUND

Crowdsourcing platform allows distribution of one or more tasks to one or more crowdworkers. The one or more crowdworkers may loosely be defined as groups of individual crowdworkers that may work on the one or more tasks. The crowdsourcing platform may receive the one or more tasks from a requestor. Each of the one or more tasks has an associated pre-defined compensation that the one or more crowdworkers will receive on completion of the one or more tasks.

Typically, the predefined compensation associated with the one or more tasks is deterministic of a number crowdworkers that may be lured to complete the one or more tasks. For example, if the compensation associated with the one or more tasks is high in comparison to a minimum wage at which a crowdworker accepts a task, a large number of crowdworkers may want to attempt the tasks. In another example, if the compensation associated with the one or more tasks is low in comparison to minimum wage at which a crowdworker accepts a task, a small number of crowdworkers may attempt the tasks. This imbalance can lead to lower level of service and may violate the Service Level Agreement (SLA) between the crowdsourcing platform and requestors.

### SUMMARY

According to embodiments illustrated herein there is provided a method for dynamically adjusting compensation for one or more tasks. The method includes estimating the compensation for each task in a batch of tasks based on at least one of a minimum wage for a task in the batch of tasks, one or more attributes associated with the worker, a number and type of tasks in the batch of tasks, or a target level of service. The compensation for the each task of the batch of tasks is then adjusted based on at least one of an observed level of service associated with the batch of tasks and the target level of service. The method is performed using a processor.

According to embodiments illustrated herein there is provided a system for dynamically adjusting compensation for one or more tasks. The system comprising a processing unit and a memory coupled to the processing unit. The memory includes a feed-forward controller module configured to estimate the compensation for each task in a batch of tasks based on at least one of a minimum wage for a task in the batch of tasks, one or more attributes associated with the worker, a number and type of tasks in the batch of tasks, or a target level of service. The memory further includes a feedback controller module configured to adjust the compensation for the each task of the batch of tasks based on at least one of an observed level of service associated with the batch of tasks or the target level of service. The processing unit executes the feedback controller module and feed-forward controller module.

According to embodiments illustrated herein there is provided a computer program product for use with a computing device. The computer program product comprising a non-transitory computer-readable medium having a computer readable program code embodied therein for dynamically adjusting compensation of one or more tasks. The computer program code includes a program instruction means for estimating the compensation for each task in a batch of tasks based on at least one of a minimum wage for a task in the batch of tasks, one or more attributes associated with the worker, a number and type of tasks in the batch of tasks, or a target level of service. Further, the computer program code includes a program instruction means for adjusting the compensation for the each task of the batch of tasks based on at least one of an observed level of service associated with the batch of tasks or the target level of service.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram illustrating a system environment in which various embodiments can be implemented;

FIG. 2 is a block diagram illustrating a system for adjusting compensation of a batch of tasks, in accordance with at least one embodiment;

FIG. 3 is a block diagram illustrating interaction between various components of system, in accordance with at least one embodiment; and

FIG. 4 is a flowchart illustrating a method for adjusting compensation of a batch of tasks, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “task” refers to a piece of work, an activity, an action, a job, an instruction or an assignment to be performed. Tasks may necessitate the involvement of one or more workers. Examples of tasks include, but are not limited to, digitization of a document, generating a report, evaluating a document, conducting a survey, writing a code, extracting data, translating text, and so forth.

“Crowdsourcing” refers to distributing tasks by soliciting the participation of loosely defined groups of individual workers. A group of workers may include, for example, individuals responding to a solicitation posted on a certain website such as, but is not limited to, Amazon Mechanical Turk and Crowd Flower.

A “crowdsourcing platform” refers to a business application, wherein a broad, loosely defined external group of people, communities, or organizations provides solutions as outputs for any specific business processes received by the application as input. In an embodiment, the business application may be hosted online on a web portal (e.g., the crowdsourcing platform servers). Various examples of the crowdsourcing platforms include, but are not limited to, Amazon Mechanical Turk or Crowd Flower.

A “worker” refers to a workforce/worker(s) that may perform one or more tasks, which generate data that contributes to a defined result such as proofreading a part of a digital version of an ancient text or analyzing a quantum of a large volume of data. According to the present disclosure, the worker(s) includes, but is not limited to, a satellite center employee, a business process outsourcing (BPO) firm employee, a home-based employee, or an internet-based employee. Hereinafter, “crowdworker”, “worker”, “remote worker” “crowdsourced workforce”, “crowdworker”, and “crowd” may be interchangeably used.

“Compensation” refers to a payment given to a crowdworker for completing a task. In an embodiment, payment for a task may correspond to at least one of monetary payment, payment through lottery tickets, point credits, or any other means to pay the crowdworker for completing the task.

“Level of service” (LOS) refers to a ratio of a number of crowdworkers accepting the task and a number of tasks in a batch of tasks.

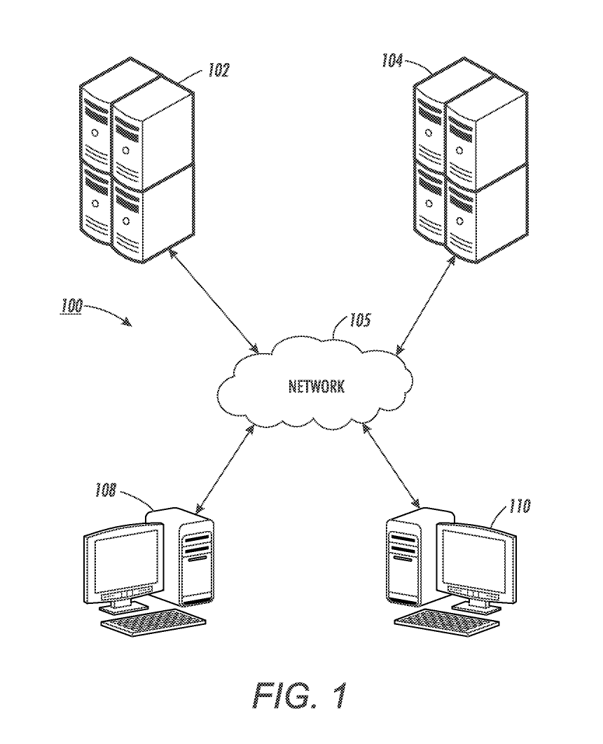

FIG. 1 is a block diagram of a system environment 100 in which various embodiments can be implemented. The system environment 100 includes a crowdsourcing platform server 102, an application server 104, a network 106, a crowdworker computing device 108, and a requestor computing device 110.

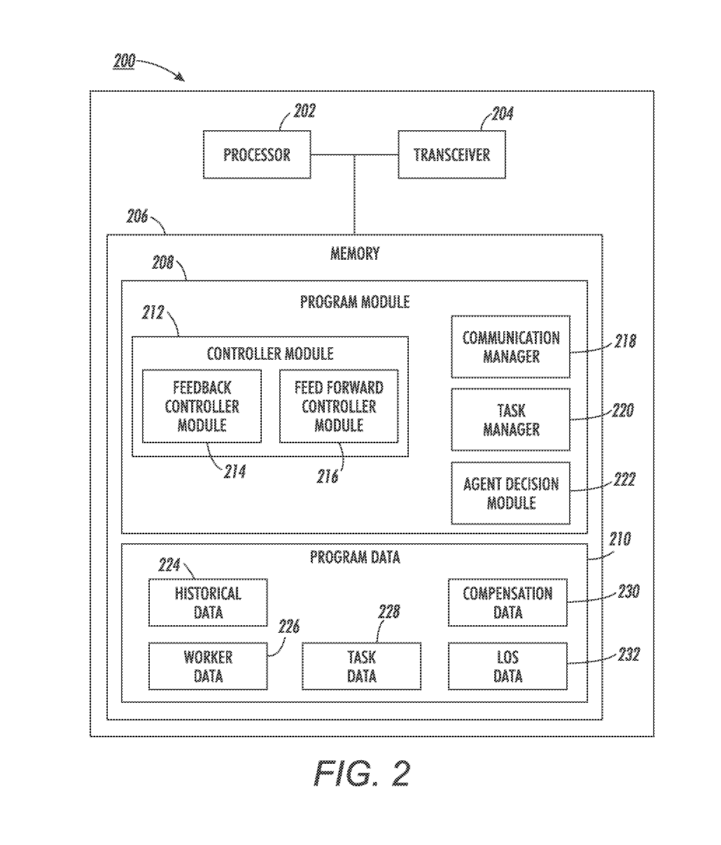

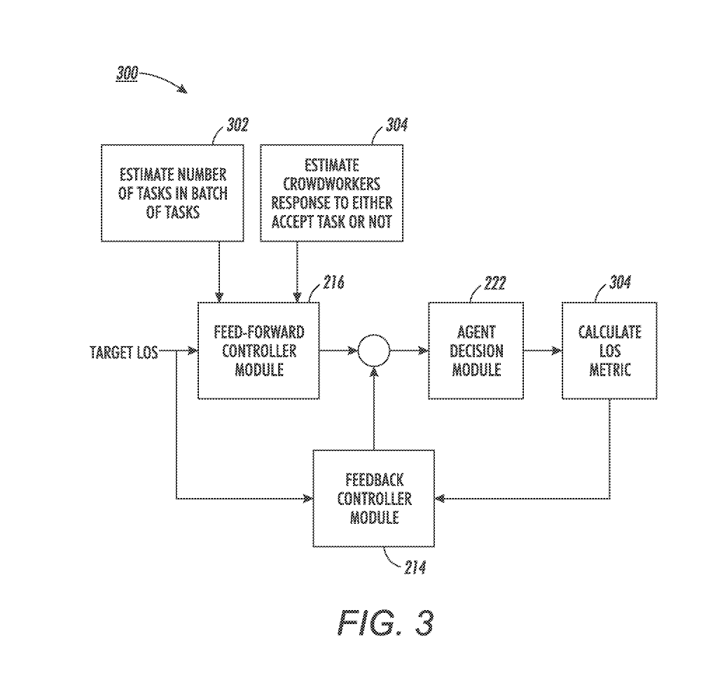

The crowdsourcing platform server 102 is configured to host one or more crowdsourcing platforms. One or more crowdworkers are registered with a crowdsourcing platform. Further, the crowdsourcing platform offers one or more tasks to the one or more crowdworkers. In an embodiment, each of the one or more tasks has an associated compensation. The crowdsourcing platform may vary the compensation associated with the one or more tasks. The varying of the compensation is described later in conjunction with FIG. 3. In an embodiment, the crowdsourcing platform presents a user interface (UI) to the one or more crowdworkers through a web based interface or a client application. The one or more crowdworkers may access the one or more tasks through the web based interface or the client application. Further, the one or more crowdworkers may submit a final work product/response to the crowdsourcing platform through the UI. The crowdsourcing platform may validate the response for quality checks. In an embodiment, the crowdsourcing platform server 102 may be realized through an application server such as but not limited to, Java application server, .NET framework, and Base4 application server. The crowdsourcing platform server 102 is described later in conjunction with FIG. 2.

The application server 104 is configured to generate the one or more tasks for completion through crowdsourcing. The application server 104 uploads the one or more tasks on the crowdsourcing platform. In an embodiment, the crowdsourcing platform distributes the one or more tasks to the one or more crowdworkers. Some examples of the application server 104 may include, but not limited to, Java application server, .NET framework, and Base4 application server.

A person skilled in the art would understand that the scope of the disclosure should not be limited to the application server 104 as a separate entity. In an embodiment, the application server 104 may be implementable on/integrated with the crowdsourcing platform server 102.

The network 106 corresponds to a medium through which content and messages flow between various devices of the system environment 100 (e.g., the crowdsourcing platform server 102, the application server 104, the requestor computing device 110, and the crowdworker computing device 108). Examples of the network 106 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 106 in accordance with various wired and wireless communication protocols such as Transmission Control Protocol and Internet Protocol (TCP/IP), User Datagram Protocol (UDP), and 2G, 3G, or 4G communication protocols.

The crowdworker computing device 108 is a computing device used by a crowdworker. The crowdworker computing device 108 is configured to present the user interface (received from the crowdsourcing platform) to a crowdworker. The crowdworker receives the one or more tasks from the crowdsourcing platform through the user interface. Further, the crowdworker submits the response through the user interface to the crowdsourcing platform. Some examples of the crowdworker computing device 108 include a personal computer, a laptop, a PDA, a mobile device, a tablet, or any device that has the capability to display the user interface.

The requestor computing device 110 is a computing device used by a requestor to send the one or more task requests to the application server 104. In an embodiment, the application server 104 then generates the one or more tasks for crowdsourcing based on the one or more task requests. In an alternate embodiment, the requestor computing device 110 may upload the one or more task requests to the crowdsourcing platform server 102. In such a scenario, the crowdsourcing platform server 102 generates the one or more tasks for crowdsourcing based on the one or more task requests. Examples of the requestor computing device 110 include, but are not limited to, a personal computer, a laptop, a personal digital assistant (PDA), a mobile device, a tablet, or any other computing device that has capability to send one or more task requests to the application server 104.

FIG. 2 is a block diagram illustrating a system 200 for adjusting compensation associated with a batch of tasks, in accordance with at least one embodiment. The system 200 includes a processor 202, a transceiver 204, and a memory 206. In an embodiment, the system 200 may correspond to the crowdsourcing platform server 102 or the application server 104. For the purpose of ongoing description, the system 200 is considered as the crowdsourcing platform server 102. However, the scope of the disclosure should not be limited to the system 200 as the crowdsourcing platform server 102. The system 200 can also be realized as the application server 104.

The processor 202 is coupled to the transceiver 204 and the memory 206. The processor 202 executes a set of instructions (as various program modules) stored in the memory 206 to perform a predetermined operation on the system 200. The processor 202 can be realized through a number of processor technologies known in the art. Examples of the processor 202 may include, but are not limited to, X86 processor, RISC processor, ASIC processor, CISC processor, ARM processor, or any other processor.

The transceiver 204 transmits and receives messages and data to/from various devices of the system environment 100 (e.g., the application server 104, the crowdworker computing device 108, and the requestor computing device 110). Examples of the transceiver 204 may include, but are not limited to, an antenna, an Ethernet port, a USB port or any other port that can be configured to receive and transmit data. The transceiver 204 transmits and receives data/messages in accordance with various communication protocols, such as, TCP/IP, UDP, and 2G, 3G, or 4G communication protocols.

The memory 206 stores a set of instructions and data. Some of the commonly known memory implementations include, but are not limited to, a random access memory (RAM), a read only memory (ROM), a hard disk drive (HDD), and a secure digital (SD) card. Further, the memory 206 includes a program module 208 and a program data 210. The program module 208 includes a controller module 212, a communication manager 218, a task manager 220, and an agent decision module 222.

The program data 210 includes a historical data 224, a worker data 226, a task data 228, a compensation data 230, and a level of service (LOS) data 232.

The controller module 212 retrieves a target LOS from the LOS data 232. In an embodiment, the target LOS is pre-defined by the administrator of the crowdsourcing platform server 102. Further, the target level of service can be a fixed value or a function of time depending on the SLA between the requestor and the crowdsourcing platform. Further, the controller module 212 retrieves an observed LOS from the LOS data 232. In an embodiment, the observed LOS corresponds to a ratio of a number of workers that accepted the tasks in a batch of tasks, and a total number of tasks in the batch of tasks. Prior to receiving the batch of tasks, the controller module 212 estimates a number of tasks that will be received in the batch of tasks based on the historical data 224. The estimation of the number of tasks in the batch of tasks is described later in conjunction with FIG. 3. Based on the target LOS, the observed LOS and the estimation of the number of tasks in the batch of tasks, the controller module 212 adjusts the compensation for the tasks in the batch of tasks. The controller module 212 includes a feedback controller module 214 and a feed-forward controller module 216.

In an embodiment, the feed-forward controller module 216 estimates the number of tasks in the batch of tasks that will be received by the crowdsourcing platform based on the historical data 224. Further, the feed-forward controller module 216 estimates a compensation for each task in the batch of tasks based on the target LOS and one or more attributes associated with each of the one or more crowdworkers. In an embodiment, the one or more attributes include, but are not limited to, an educational qualification, a work experience, a number of tasks completed by the crowdworker, crowdworker's interests, crowdworker's value of time, a minimum wage acceptable to a crowdworker, or certifications. The operation of the feed-forward controller module 216 is described later in conjunction with FIG. 3. In an embodiment, the feed-forward controller module 216 estimates the compensation for a predefined time interval. The feedback controller module 214, on receiving the batch of tasks, determines a difference between the observed LOS and the target LOS. Based on the difference, the feedback controller module 214 adjusts the compensation for the batch of tasks. In an embodiment, the controller module 212, the feedback controller module 214, and the feed-forward controller module 216 can be implemented using at least one of a PID controller, Fuzzy-PID controller, or Fuzzyneuro-PID controller.

A person skilled in the art would understand that the scope of the disclosure should not be limited to the controller module 212 as a set of instructions in the memory 206. In an embodiment, the controller module 212 can be implemented as a system on chip (SOC) or a field program gate array (FPGA).

The communication manager 218 receives the batch of tasks from the requestors through the transceiver 204. Further, the communication manager 218 facilitates the UI to the crowdworker computing device 108 through the transceiver 204. The communication manager 218 receives responses for the one or more tasks from the one or more crowdworkers through the UI. The communication manager 218 includes various protocol stacks such as, but not limited to, TCP/IP, UDP, and 2G, 3G, or 4G communication protocols. The communication manager 218 transmits and receives the messages/data (e.g., images) through the transceiver 204 in accordance with such protocol stacks.

The task manager 220 receives the batch of tasks through the communication manager 218. For each task in the batch of tasks, the task manager 220 associates a compensation estimated by the feed-forward controller module 216. The task manager 220 stores the batch of tasks along with the details pertaining to the compensation as the task data 228. Further, the task manager 220 maintains the historical data 224 with respect to the batch of tasks received in the predefined time interval. Further, the task manager 220 presents each task in the batch of tasks to the one or more crowdworkers through the UI. In an embodiment, the one or more crowdworkers may accept a task being presented to them through the UI.

The agent decision module 222 captures whether the one or more crowdworkers have accepted a task from the batch of tasks. Based on the decision of the one or more crowdworkers and a number of tasks in the batch of tasks, the agent decision module 222 determines the observed LOS. The agent decision module 222 stores the observed LOS as the LOS data 232. Further, the agent decision module 222 updates the historical data 224 based on the observed LOS for the batch of tasks.

FIG. 3 is a block diagram 300 illustrating interaction between various components of the system 200, in accordance with at least one embodiment. The block diagram 300 is described in conjunction with FIG. 1 and FIG. 2.

A person having ordinary skills in the art would understand that the arrows indicated in the block diagram 200 represents program control transfer and/or data transfer among the various program modules through the memory 206.

The feed-forward controller module 216 estimates a number of tasks that the crowdsourcing platform may receive in a predefined time interval based on the historical data 224 (depicted by 302). In an embodiment, following table illustrates a sample historical data:

TABLE 1
An example the historical data

| Time of Day | Number of tasks received |
|---|---|
| 3:00PM-3:30PM | 100 |
| 3:30PM-4:00PM | 150 |
| 4:00PM-4:30PM | 50 |

The feed-forward controller module 216 analyzes the historical data 224 to estimate the number of tasks that the crowdsourcing platform may receive during a predefined time interval. For example, usually between “3:00 PM-3:30 PM” the crowdsourcing platform receives 100 tasks from the requestor. Similarly, usually between “4:00 PM-4:30 PM” the crowdsourcing platform server receives 50 tasks from the requestor. Based on the historical data 224, the feed-forward controller module 216 estimates a number of tasks that the crowdsourcing platform may received. For example, the feed-forward controller module 216 may estimate that the crowdsourcing platform may receive 50 tasks between “4:00 PM-4:30 PM”. In an embodiment, the feed-forward controller module 216 utilizes at least one of regression analysis, pattern identification, one or more probabilistic models to estimate the number of tasks based on the historical data 224.

The feed-forward controller module 216 estimates the compensation for each task in the batch of tasks based on the target LOS, the number of tasks that the crowdsourcing platform may receive (depicted by 302), and an estimate of a number of crowdworkers who may accept the tasks (depicted by 304). For example, if the estimated number of tasks in the batch is 100 and the LOS requirement is 75% (i.e., 75 crowdworkers are needed to work on the 100 tasks), then the compensation for the 75 crowdworkers would be set to be higher than the respective minimum acceptable wages of 75 crowdworker.

For the estimated compensation, the feed-forward controller module 216 predicts whether the compensation will be acceptable to the one or more crowdworkers (depicted by 304).

$$Decision whether corwdworker will accept a task = \{ \begin{matrix}No , & w + a - c < ω \\ Yes , & w + a - c \geq ω\end{matrix} \qquad ( 1 )$$

where,
w: Estimated compensation;
a: Amenity;
c: Cost to complete a task; and
ω: Minimum compensation acceptable to the crowdworker.

The feed-forward controller module 216 predicts that the crowdworker will accept the task if the estimated compensation and the cost of complete the task greater than the minimum compensation acceptable to the crowdworker. In order to determine the minimum compensation that a crowdworker from the one or more crowdworkers will accept, the feed-forward controller module 216 utilizes following equation to determine the minimum compensation:

$$ω = \frac{p ( y ) + p ( y + 1 )}{2 t} \qquad ( 2 )$$

where,
p(y): Compensation for y tasks;
y: Maximum number of tasks that the crowdworker can take up; and
t: Time consumed by the crowdworker to complete y tasks.

Based on the minimum compensation acceptable to the crowdworker (ω), the feed-forward controller module 216 updates the estimation of the compensation for each task in the batch of tasks.

In real time, the task manager 220 receives the batch of tasks from the requestor. The task manager 220 associates compensation with each task in the batch of tasks as estimated by the feed-forward controller module 216. The task manager 220 presents the one or more tasks to the one or more crowdworkers through the UI. In an embodiment, the task manager 220 communicates details associated with the one or more tasks to the one or more crowdworkers. In an embodiment, the details related to the task include, but are not limited to, the compensation associated with tasks in the batch of tasks, a type of tasks, a time duration associated with the tasks, etc. In an embodiment, the one or more crowdworkers may accept or reject the tasks being presented to them by the task manager 220. In an embodiment, the agent decision module 222 captures the decision of the one or more crowdworkers.

In an embodiment, the number of tasks in the batch of tasks received by the task manager 220 can be different from the number of tasks estimated by the feed-forward controller module 216. Further, estimation of minimum wage of the one or more crowdworkers by the feed-forward controller module 216 may be different from the actual minimum wage of the one or more crowdworkers. Such deviation from the estimation (by the feed-forward controller module 216) may lead various implications such as wrong estimation of the compensation for each task in the batch of tasks. Such wrong estimation may hamper the LOS. In order to counter the wrong estimation, the agent decision module 222 determines an observed LOS (depicted by 306) based on the decisions of the one or more crowdworkers (i.e., to accept or reject the task). In an embodiment, the agent decision module 222 utilizes following equation to determine the observed LOS:

$$Observed LOS : \frac{Total number of crowdworkers accepting a task}{Total number of tasks in the batch of tasks} \qquad ( 3 )$$

The agent decision module 222 stores the observed LOS as the LOS data 232.

The observed LOS is indicative of deviation from the estimated LOS. The feedback controller module 214 determines the deviation of the observed LOS from the target LOS. Based on the deviation, the feedback controller module 214 adjusts the compensation of each task in the batch of tasks. In an embodiment, the feedback controller module 214 utilizes following equations to adjust the compensation:

e=Target LOS−Observed LOS (4)

where,
e: Deviation of the observed LOS from the target LOS.

$$Change in compensation = {K}_{p} ( e ) + {K}_{i} {\int }_{0}^{T} e ( t ) d t + {K}_{d} \frac{d e}{d T} \qquad ( 5 )$$

where,
Kₚ: Proportional gain;
Kᵢ: Integral gain;
K_{d}: Derivative gain;
T: The predefined time period.

New compensation=Estimated compensation+Change in compensation (6)

The feedback controller module 214 updates the compensation associated with each task in the batch of tasks based on the new compensation determined using equation 6.

The agent decision module 222 updates the historical data 224 with the observed LOS. Additionally, the task manager 220 updates the historical data 224 with the number of tasks received in the batch of tasks during the predefined time interval.

The feedback controller module 214 keeps adjusting the compensation of the tasks in the batch of tasks until the desired LOS in achieved.

For example, a crowdsourcing platform usually receives tasks related to digitization. In order to determine compensation rate for the tasks, the crowdsourcing platform includes the feed-forward controller module 216 for estimating a number of tasks that the crowdsourcing platform may receive during a given time duration. For example, the feed-forward controller module 216 determines that the crowdsourcing platform may receive 100 tasks in next 30 minutes. The crowdsourcing platform needs to maintain an LOS of “0.5”. Thus, based on the number of tasks (i.e., 100) and the target LOS (i.e., 0.5), the feed-forward controller module 216 estimates compensation for each task in the batch of tasks. For instance, assume that the compensation for each task is USD 4.

When the crowdsourcing platform receives the tasks through the task manager 220, the compensation of USD 4 is assigned to each task. For instance, the number of tasks received by the crowdsourcing platform is less than 100 tasks (as estimated by the feed-forward controller module 216). Further, the LOS observed by the agent decision module 222 is “1”. Therefore, there is a deviation of 0.5 from the target LOS.

The feedback controller module 214 utilizes the deviation (i.e., 0.5) to determine a new compensation rate for the tasks. As the observed LOS is greater than the target LOS, the feedback controller module 214 reduces the compensation for each task. For instance, the compensation is reduced to USD 3.5. As the compensation is reduced, the number of crowdworkers that accept to complete the task also reduces. Due to which the observed LOS reduces from “1”.

The feedback controller module 214 keeps on the adjusting the compensation for the tasks until the target LOS is achieved.

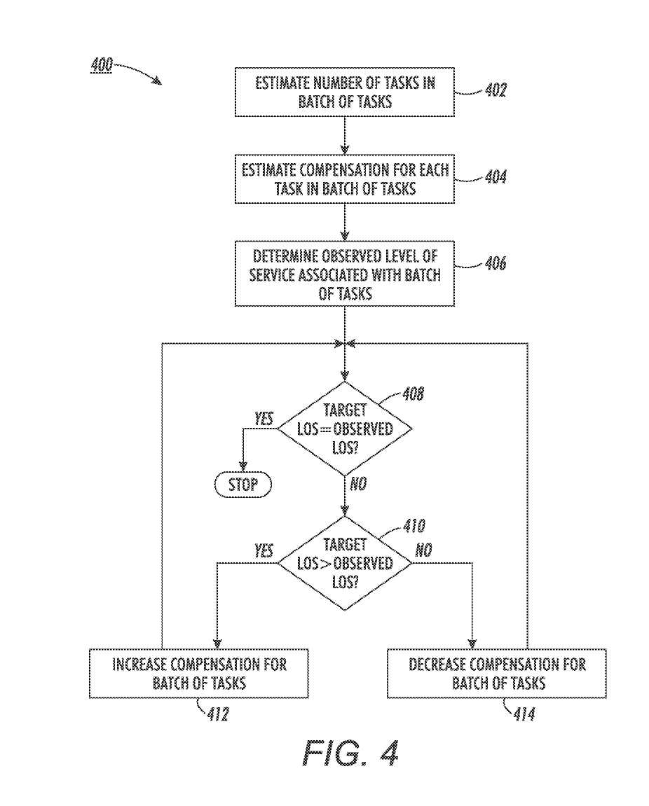

FIG. 4 is a flowchart 400 illustrating a method for adjusting compensation of the batch of tasks, in accordance with at least one embodiment. The flowchart 400 is described in conjunction with FIG. 1, FIG. 2, and FIG. 3.

At step 402, the number of tasks in the batch of tasks, which will be received by the crowdsourcing platform, is estimated. In an embodiment, the feed-forward controller module 216 estimates the number of tasks.

At step 404, the compensation for each task in the batch of tasks is estimated. In an embodiment, the feed-forward controller module 216 estimates the compensation for the task. As described in conjunction with FIG. 3, the feed-forward controller module 216 estimates the compensation by utilizing equations 1 and 2.

Based on the estimated compensation, the feed-forward controller module 216 predicts whether a crowdworker from the one or more crowdworkers accepts the task from the batch of tasks.

Thereafter, the task manager 220 receives the batch of tasks from the requestor. The task manager 220 assigns the estimated compensation value to each task in the batch of tasks. Further, the task manager 220 communicates the batch of tasks along with the details related to the compensation associated with the batch of tasks to the one or more crowdworkers.

At step 406, the observed LOS is determined. In an embodiment, the agent decision module 222 determines the observed LOS. The agent decision module 222 keeps a track of number of crowdworkers that have accepted the tasks. In an embodiment, the agent decision module 222 utilizes equation 3 to determine the observed LOS.

At step 408, a check is performed whether the observed LOS is equal to the target LOS. In an embodiment, the feedback controller module 214 performs the check. If at step 408, it is determined that the observed LOS is not equal to the target LOS, step 410 is performed.

At step 410, a check is performed whether the observed LOS is less than the target LOS. In an embodiment, the feedback controller module 214 performs the check. If at step 410 it is determined that the observed LOS is less than the target LOS, the step 412 is performed. At step 412, the compensation associated with the batch of tasks is increased. In an embodiment, the feedback controller module 214 increases the compensation for the batch of tasks.

If at step 410 it is determined that, the observed LOS is greater than the target LOS, the step 414 is performed. At step 414, the compensation associated with the batch of tasks is decreased. In an embodiment, the feedback controller module 214 decreases the compensation for the batch of tasks.

The disclosed embodiments encompass numerous advantages. The feed-forward controller module 216 estimates a number of tasks that the crowdsourcing platform may receive. Further, the feed-forward controller module 216 estimates the compensation for each of task to achieve the desired LOS. In an actual or real time scenario, the estimated number of tasks may differ from the actual number of tasks received by the crowdsourcing platform. Additionally, the decision simulation by the feed-forward controller module may not exactly match the decisions taken by real crowdworkers. Thus, the feedback controller module 214 adjusts the compensation for the tasks to counter such variations. Therefore, estimating compensation for the tasks beforehand and later adjusting to compensation of the tasks helps achieving the target LOS faster. Further, dynamic compensation may minimize SLA violations between the crowdsourcing platform and requestors.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for adjusting compensation for tasks have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for dynamically adjusting compensation for one or more tasks, the method comprising:
estimating, by a processor, the compensation for each task in a batch of tasks based on at least one of a minimum wage for a task in the batch of tasks, one or more attributes associated with the worker, a number and type of tasks in the batch of tasks, or a target level of service; and
adjusting, by a processor, the compensation for the each task of the batch of tasks based on at least one of an observed level of service associated with the batch of tasks and the target level of service.

2. The method of claim 1, wherein the compensation is estimated at pre-defined time intervals.

3. The method of claim 1, wherein the one or more attributes corresponds to at least one of an educational qualification, a work experience, a number of tasks completed by the worker, worker's interests, worker's value of time, or certifications.

4. The method of claim 1 further comprising estimating, by a processor, a number of tasks in the batch of tasks based on a historical data corresponding to a previous batch of tasks.

5. The method of claim 1, wherein the compensation for each task of the batch of tasks is increased when the observed level of service is less than the target level of service.

6. The method of claim 1, wherein the compensation for each task of the batch of tasks is decreased when the observed level of service is greater than the target level of service.

7. The method of claim 1 further comprising communicating, by a processor, at least the details of the batch of tasks to the worker, wherein the details comprises at least details related to the compensation associated with the batch of tasks.

8. The method of claim 1 further comprising receiving, by a processor, an acceptance or a rejection for the task from the batch of tasks by the worker.

9. The method of claim 8, wherein the worker accepts or rejects the task based on at least one of a time required to complete the batch of tasks, the compensation received on completing the task, or an effort required to complete the task.

10. The method of claim 1, wherein the level of service corresponds to at least a ratio of a number of workers accepting the task and a number of tasks in a batch of tasks.

11. A system for dynamically adjusting compensation for one or more tasks, the system comprising:
a processing unit; and
a memory coupled to the processing unit comprising:
a feed-forward controller module configured to estimate the compensation for each task in a batch of tasks based on at least one of a minimum wage for a task in the batch of tasks, one or more attributes associated with the worker, a number and type of tasks in the batch of tasks, or a target level of service; and
a feedback controller module configured to adjust the compensation for the each task of the batch of tasks based on at least one of an observed level of service associated with the batch of tasks or the target level of service,
wherein the processing unit executes the feedback controller module and feed-forward controller module.

12. The system of claim 11, wherein the feed-forward controller module is further configured to determine whether the worker accepts the tasks based on the minimum wage.

13. The system of claim 11, wherein the feed-forward controller module estimates a number of tasks in the batch of tasks based on a historical data corresponding to a previous batch of tasks.

14. The system of claim 11, wherein the memory further comprises a communication manager configured to communicate at least the details of the batch of tasks to the worker, wherein the details comprises at least details related to the compensation associated with the batch of tasks.

15. The system of claim 11, wherein the memory further comprises an agent decision module configured to receive an acceptance or a rejection for the batch of tasks by the worker.

16. The system of claim 15, wherein the worker accepts or rejects the task from the batch of tasks based on at least one of a time required to complete the task, the compensation received on completing the task, and an effort required to complete the task.

17. The system of claim 11, wherein the feedback controller module is configured to decrease the compensation for each task in the batch of tasks when the observed level of service is greater than the target level of service.

18. The system of claim 11, wherein the feedback controller module is configured to increase the compensation for each task in the batch of tasks when the observed level of service is less than the target level of service.

19. A computer program product for use with a computing device, the computer program product comprising a non-transitory computer-readable medium having a computer readable program code embodied therein for dynamically adjusting compensation of one or more tasks, the computer program code comprising:
program instruction means for estimating the compensation for each task in a batch of tasks based on at least one of a minimum wage for a task in the batch of tasks, one or more attributes associated with the worker, a number and type of tasks in the batch of tasks, or a target level of service; and
program instruction means for adjusting the compensation for the each task of the batch of tasks based on at least one of an observed level of service associated with the batch of tasks or the target level of service.
